(19) United States
(12) Patent Application Publication
(10) Pub. No.: US 2003/0036989 A1
(43) Pub. Date: Feb. 20, 2003

(54) Systems and method for online investing

(76) Inventor: Sanjiv Bhatia, Charlottesville, VA (US)

Correspondence Address: Winstead Sechrest & Minick P.C., 5400 Renaissance Tower, 1201 Elm Street, Dallas, TX, 75270, US

(21) Appl. No.: 09/858,262

(22) Filed: May 15, 2001

(51) Int. Cl. G06F 17/60

(52) U.S. Cl. 705/36

(57) ABSTRACT

A method of managing indexed investment products via a computer network includes the step of generating a set of portfolios, each portfolio composed of weighted classes of assets and associated with a degree of loss aversion. The set of portfolios are stored in a database. A set of return distributions are generated for each portfolio for selected investment options and horizon dates and stored in a database. A selected portfolio is matched with an online investor in response to degree of loss aversion information input from the online investor. The online investor is then provided a return distribution associated with the selected portfolio in response to investment option and horizon date information input from the online investor.

### BACKGROUND OF THE INVENTION

1. Field of the Invention

The present invention relates in general to networked systems and in particular to systems and methods for online investing.

2. Description of the Related Art

Capital markets the world over are changing at a rapid pace, particularly in view of the wide reach and acceptance of global computer networks such as the Internet and the World Wide Web. These computer networks give individual investors access to the worldwide markets to a degree formerly available only to more traditional institutional investors. This capability, coupled with a number of other trends, is revolutionizing the investment industry and the paradigms under which it operates.

Generally, the number of individual investors is rapidly increasing. In the U.S. alone there are over 80 million individual investors, and globally, over half a billion. Of these, over 4 million U.S. investors invest online—a number which is expected to climb to over 10 million in the next few years. These numbers continue to grow as self-directed retirement programs and similar investment products which encourage individual participation in the markets become the norm.

The growth in the number of individual investors is creating an explosive need for customized investment advice. At the same time, individual investors are becoming more sophisticated and are demanding performance from their brokers and investment advisors. In particular, investors are becoming increasingly concerned about the high cost of money management services. This awareness has led to the realization that active management has not provided the return performance needed to justify its high costs.

The challenge is therefore to provide high quality, accessible, investment advice at a reasonable cost. Among other things, management techniques are required which provide a comprehensive solution which addresses a wide range if issues faced by the individual investor.

### SUMMARY OF THE INVENTION

The principles of the present invention are embodied in methods and software for managing indexed investment products via a computer network. According to one such method, a set of portfolios are generated, each portfolio composed of weighted classes of assets and associated with a degree of loss aversion, and stored in a database. A set of return distributions are also generated for each portfolio for selected investment options and horizon dates and stored in the database. A selected portfolio is then matched with an online investor in response to degree of loss aversion information input from the online investor. The online investor can then be provided with a return distribution associated with the selected portfolio in response to investment option and horizon date information input from the online investor.

Methods and software embodying the principles of the present invention provide substantial advantages over the prior art. In particular, individual investors now have the means for investing in indexed products directly online. In turn, a subscribing investor can take more control over the management of his or her portfolio which in turn allows for a substantial reduction in the costs of money management services.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a high level flow chart illustrating a preferred online investment method according to the inventive principles;

FIG. 2 illustrates a preferred data structure for an Account Profile for use in implementing the methods of FIG. 1;

FIG. 3 is a diagram showing the menus available on the preferred New User Home page;

FIG. 4 describes the preferred menus and options available for the registered user (client);

FIG. 5A is a diagram illustrating a preferred procedure for adding an Account Profile to the database;

FIG. 5B illustrated the preferred procedure for changing an existing account;

FIG. 5C illustrates a preferred procedure for changing the Account Objective;

FIG. 5D illustrates the Planning (Replanning) procedure in further detail; and

FIG. 5E illustrates the preferred process for changing the investment mix.

### DESCRIPTION OF THE PREFERRED EMBODIMENTS

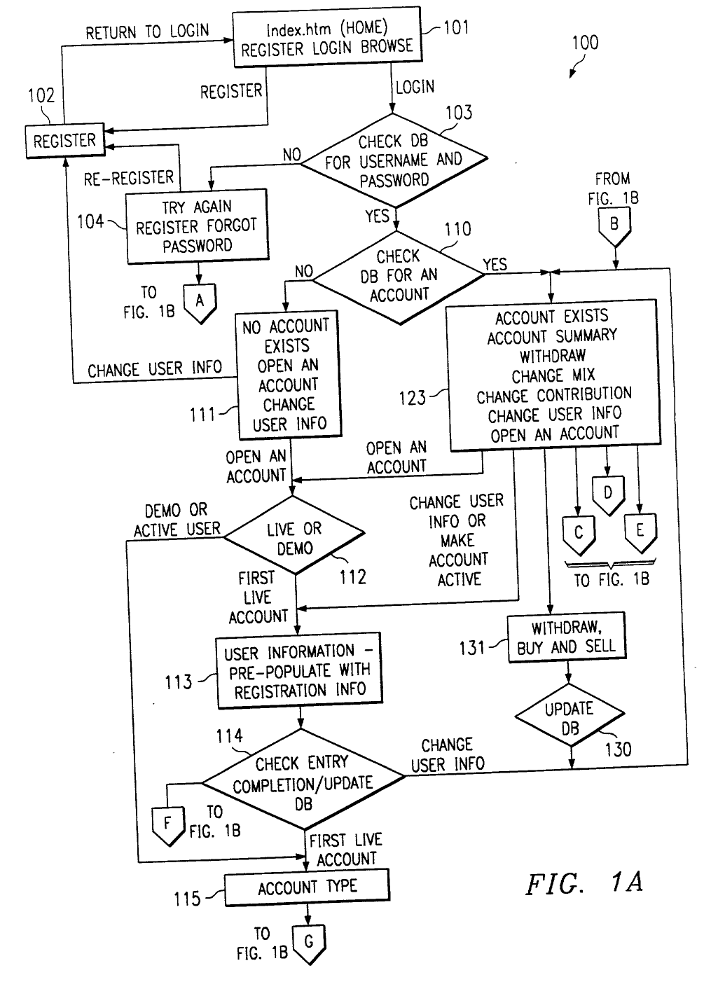

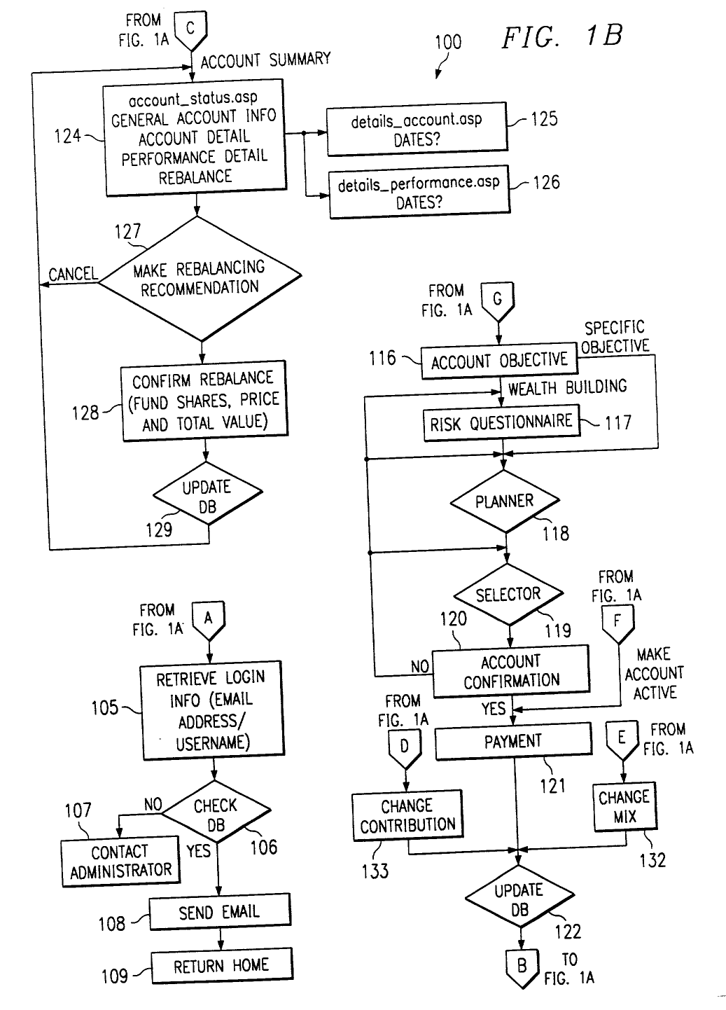

The principles of the present invention and their advantages are best understood by referring to the illustrated embodiment depicted in FIGS. 1-5 of the drawings, in which like numbers designate like parts.

One form of passive investment management is through indexed products, such as indexed funds. Indexed products are designed to mirror the performance of a specific financial index, such as the Dow Jones Industrial Average or the S & P 500. These products are “passive” since, generally, decisions are automatic and often infrequent, thereby limiting the intervention of a professional money manager. Notwithstanding, investors, in particular those investing online, still require access to low-cost, top-quality services in order to select, track and manage portfolios of indexed products. For example, an investor may need full-time portfolio tracking capability, real-time portfolio rebalancing support, full-time access to account information, feedback with regards to portfolio performance relative to stated objectives and the ability to easily change the portfolio asset mix.

According to the principles of the present invention, Modern Portfolio Theory (MPT) and the theory of Efficient Markets are advantageously combined in the management of portfolios of indexed products. Generally, MPT argues that investors will have a higher return for a given level of risk (or conversely a lower level of risk for a given level of return) if they invest in a well constructed portfolio of assets as opposed to a random investment in stocks or mutual funds. To this end, the science of Asset Allocation uses quantitative techniques to find portfolio mixes that are ex ante more efficient (optimized) than others and then maps them on a curve called the Efficient Frontier. The theory of Efficient Markets argues that as capital markets become more mature, informational asymmetries disappear and all participants receive information about stocks and companies at the same time. In other words, that when information is widely available to investors, the value of assets change immediately to reflect any new information before investors can profit thereby. This implies that investors, including professional money managers, cannot profit consistently from any information they may have. The theory is confirmed by an overwhelming body of evidence indicating that the average professional money manager is not able to out perform the market as a whole over the long term.

The inventive concepts are embodied in both methods and software for managing indexed product portfolios via global computer networks, such as the Internet or World Wide Web. This system is particularly advantageous in view of the increasing number of individual investors who are taking responsibility over their retirement and/or general investment accounts. According to the inventive concepts, an investor is provided with a visual display reflecting the expected impact on portfolio performance as one or more variables are changed with respect to asset mix, expected rate of return, best/worst case scenario, and the probability of reaching the stated financial goal over a specified time horizon.

An Asset Allocation exercise is performed and then optimized to determine an optimal portfolio mix. Specifically, a Growth Optimization System (GOS) uses three moments to identify portfolios which have the potential to generate the highest return with the lowest level of risk; namely, the mean, standard deviation and kurtocity (which describes the shape of the distribution). This is in contrast to existing models which only use the mean and standard deviation moments to quantitatively evaluate portfolios. Moreover, unlike previous methods of portfolio evaluation, risk is considered as a second order effect. In other words, instead of basing the entire Asset Allocation decision on the investors tolerance for risk, the financial goals of the investor are the primary drive of the Asset Allocation process and risk is then factored in.

The first step in the inventive process is to identify those portfolios having an expected a rate of return higher than the average rate of return the investor would need to achieve the stated financial goal. MPT suggests the construction of portfolios that are based not only on expected return considerations, but also on expected risk and the correlation between different assets in the portfolio. An optimal portfolio has the potential to provide the highest rate of return for the given level of risk. The present optimization techniques therefore take in to account several factors in constructing portfolio mixes including: (1) the highest expected rate of return for a chosen level of risk; (2) the lowest level of risk for a chosen level of desired return; and (3) the lowest probability of large negative returns (i.e. the lowest downside risk).

Every portfolio mix is given a unique expected final value. Once the portfolios have been identified, a simulation is run to determine the expected worst and best-case values for each portfolio mix. Investors are then able to access a visual display showing the spread between the best and worst-case scenarios and determine how potential risk effects the expected final outcome.

From this, the investor can select the portfolio mix that corresponds to their desired return and risk levels.

The GOS Subroutine Library, optimizes portfolios consisting of asset classes using a nonlinear programming algorithm which optimizes growth while still providing downside protection. A growth optimal portfolio is constructed by maximizing an expected utility function. Downside protection is achieved as a function of a given Degree of Loss Aversion (DLA), wherein the growth optimal portfolio is the special case where the DLA is zero and the greater the DLA, the greater the downside protection which is added to the portfolio. Thus, for an aggressive investor, the specified DLA for the portfolio construction is low, while for a conservative investor, the specified DLA is high. The rate of convergence of the algorithm is either super linear or quadratic, depending on the mathematical assumptions made.

In the preferred embodiment, the nonlinear programming algorithm used is that described in Best and Ritter, A Class of Accelerated Conjugate Direction Methods for Linearly Constrained Minimization Problems, Mathematics of Computation, Vol. 30, Number 135 (July 1976). In this case, the portfolios are selected as a function of return distribution. When the DLA is set to zero, this technique selects a portfolio which maximizes the natural log utility function. This in turn maximizes the portfolio growth rate over time. For higher values of DLA, the portfolios are selected such that the left tail of the portfolio return distribution is reduced relative to the portfolio that corresponds to a DLA of zero. The higher the value of the DLA, the greater the reduction in the probability in the left tail of the portfolio return distribution. It should be noted that while the preferred non-linear programming algorithm is that described in the above identified paper, implementation of the inventive principles are not limited thereto.

The GOS routines operate in response to three sets of arguments, with the arguments of each set preferable arranged alphabetically. These three sets of arguments are the dimensioning variables, the data input and the output.

The dimensioning variables are inputs which define the number of assets for which joint returns data is provided (numapv), the number of asset attributes (numatr) and the number of periods of joint returns data (numper). The set of input data is organized in one dimensional arrays specified by the dimensioning variables. Any array specified as the product of two of the dimensioning variables can be considered as a two-dimensional array. In this case, the first dimensioning variable represents the number of rows in the array and the second dimensioning variable represents the number of columns. One dimensional arrays can be created from the two dimensional arrays by storing data by column.

Table 1 summarizes the input data fields:

TABLE 1

| Input Field | Description | Dimension | Ordering |
|---|---|---|---|
| astlb | Lower bound on assets in the | numapv | |
| | approved list (followed list). | | |
| | This lower bound is required, | | |
| | even if it is a large negative | | |
| | number. The order of the | | |
| | assets in the array is the same | | |
| | as that in the joint returns array | | |
| | (jointret) | | |
| astub | Upper bound on assets in the | numapv | |
| | approved list (followed list). | | |
| | This upper bound is required, | | |
| | even if it is a large positive | | |
| | number. The order of the | | |
| | assets in this array is the same | | |
| | as that in the joint returns array | | |
| | (jointret) | | |
| atribs | Asset attributes. To | numapv* | |
| | accomodate the budget | numatr | |
| | constraint, set one of the | | |
| | attributes equal to 1 for each | | |
| | asset. For example, the value | | |
| | of the first attribute can be set | | |
| | to 1 for each asset. The asset | | |
| | attributes are used to calculate | | |
| | the corresponding portfolio | | |
| | attributes, which can be | | |
| | constrained in the optimization. | | |
| | For example, for a stock | | |
| | portfolio one of the attributes | | |
| | could be the asset beta | | |
| | Type: array of double | | |
| conlb | Lower bounds on linear | numatr | |
| | constraints. The linear | | |
| | constraints are constraints on | | |
| | the optimal portfolio's | | |
| | attributes. A portfolio attribute | | |
| | is the weighted average of the | | |
| | asset attributes for the assets | | |
| | in the portfolio, where the | | |
| | investment weight is used for | | |
| | calculating the weighted | | |
| | average. For example, for a | | |
| | stock portfolio the portfolio beta | | |
| | is an investment weighted | | |
| | average of the asset betas. If | | |
| | there is no bound set for an | | |
| | attribute, put −999.0 for the | | |
| | bound, where −999.0 indicates | | |
| | not specified. For an equality | | |
| | constraint set the lower and | | |
| | upper (conub) bounds to the | | |
| | same value, such as 1.00 for | | |
| | the budget constraint. The | | |
| | constraints on the attributes | | |
| | are specified in the same order | | |
| | as the asset attributes are | | |
| | stored in the atribs array. | | |
| | Type: array of double | | |
| connum | Constraint number. The | numatr | |
| | constraint number is the same | | |
| | as the asset attribute number, | | |
| | and the number of constraints | | |
| | is equal to the number of asset | | |
| | attributes. Type: array of short | | |
| | int | | |
| conub | Upper bounds on linear | numatr | |
| | constraints. See conlb for | | |
| | additional information on linear | | |
| | constrain bounds. Type: array | | |
| | of double | | |
| dla | The Degree of Loss Aversion, | | |
| | which must be zero or grater | | |
| | than zero. This parameter | | |
| | controls the amount of | | |
| | downside protection built into | | |
| | the portfolio. If it is set to zero, | | |
| | the resulting portfolio is growth | | |
| | optimal. For numbers greater | | |
| | than zero, downside protection | | |
| | is added to the portfolio. The | | |
| | larger of the Degree of Loss | | |
| | Aversion specified, the greater | | |
| | the amount of downside | | |
| | protection added to the | | |
| | portfolio. Type: double | | |
| inipwt | Asset weights in the initial | numapv | |
| | portfolio. The order of the | | |
| | assets in this array is the same | | |
| | as that in the joint returns array | | |
| | (jointret). If an asset in the | | |
| | joint returns array is not in the | | |
| | initial portfolio, set its weight to | | |
| | 0.00. Type: array of double | | |
| jointret | Joint returns for all assets. | numper* | |
| | Type: array of double | numapv | |
| prob | probabilities associated with | numper | |
| | the joint returns. Type: array | | |
| | of double | | |
| OUTPUT | | | |
| error | Errorcode. Type: long | | |
| optimal | Asset weights for the optimal | numapv | |
| | portfolio. The order of the | | |
| | assets in this array is the same | | |
| | as that in the join returns array | | |
| | (jointret). | | |

The output data includes a set of error codes and asset weights for the optimal portfolio. The asset weights are output as arrays of dimension numapv. A series of portfolios consisting of the selected asset classes are created for different DLA values and stored in a database. These portfolios can then be matched with different types of investors depending on their tolerance to risk. (The error codes indicate, among other things, things that required input information to the optimizer is missing or inconsistent, processing constraints or parameters are not valid, memory errors, etc.)

One possible Portfolio Allocation Table which can be set up in the database:

TABLE 2
Portfolio Allocation Table

| | | | | | | |
|---|---|---|---|---|---|---|
| Portfolio | Degree | Weight | Weight | Weight | Weight | Weight |
| Number | of Loss | for | for | for | for | for |
| | Aversion | Asset | Asset | Asset | Asset | Asset |
| | | Class A | Class B | Class C | Class D | Class E |

The simulation step is designed to generate a return distribution for a given portfolio for a given future horizon date. Preferably, this portfolio return distribution is based on the assumption of a given ratio of an initial investment to periodic additional investments. For example, the initial investment could be made at the beginning of a first time period and the additional investments made at the end of the first time period and at the end of every defined time period thereafter until the horizon date is reached.

The simulation starts with an estimation of a portfolio return distribution for one period from the joint return distribution of the selected classes for a given portfolio. The portfolio used in the simulation is selected from the portfolios generated by the optimization step. A Monte Carlo simulation is taken through a random path of the portfolio returns through all time periods up to the horizon date. In particular, data are sampled from one period portfolio return distribution and then the compounded average return for the portfolio is calculated for that random path. The random walk is repeated until the number of paths sampled is sufficient to generate an acceptable portfolio return distribution for the given time horizon.

In the preferred embodiment, the simulation inputs include the asset investment weights in the portfolio, the joint return distribution of the asset returns, the initial investment, the periodic investments and the number of simulation trials. Here, the one-period portfolio return distribution is constructed from the asset investment rates and the joint return distribution of asset returns. Then the specified number of simulation trials are run; during each simulation trial, a random return is repeatedly generated for each period starting with the the current period and ending with the specified future period. Given the initial investment, the periodic investment and the series of randomly generated returns, the portfolio's ending value at the specified future period is calculated. Using a set of cash inflows and the ending portfolio value, the internal rate of return is also calculated for the portfolio. The set of internal rates of return are then sorted to produce the portfolio return distribution at the specified future period, which is the simulator output in the preferred embodiment.

To this end, in the preferred embodiment, the first factor weighed is the desired goal and the second the risk tolerance. This embodies the concept that the biggest risk is not reaching the financial goal. The inventive system is then able to display the varies mixes projected to reach the financial goal along with the risk associated with each mix such that the investor can make an informed choice when selecting the mix. Additionally, a psychometrically designed on-line risk questionnaire is used for objective analysis of the investors's tolerance of risk.

The portfolio return investment ratio is stored in a database and is retrievable as a function of the investor's tolerance to risk, the time horizon and the savings pattern. TABLE 3 illustrates an exemplary database structure, where each period is assume to be one year. This database is preferable updated during each update of the Portfolio Allocation Table.

TABLE 3
Simulation Results Table

| | | | | | | |
|---|---|---|---|---|---|---|
| Portfolio | Time | Initial to | Annualized | Probability of | Best Case | Worst |
| Number | Horizon | Periodic | Expected | Getting the | Annualized | Case |
| | in Years | Investment | Return | Annualized | Return | Annualized |
| | | Ratio | | Expected | | Return |
| | | | | Return or | | |
| | | | | Higher | | |

TABLE 3B
Annualized Return at the Cumulative Probability Level

| | | | | | | |
|---|---|---|---|---|---|---|
| Portfolio | Time | Initial to | 5% | 10% | — | 95% |
| Number | Horizon | Periodic | | | | |
| | in Years | Investment | | | | |
| | | Ratio | | | | |

FIG. 1 is a flow chart illustrating the operation of an interactive, web-based system 100 for investing in indexed financial products. System 100 is particularly suitable for use by individual investors, although not necessarily limited thereto.

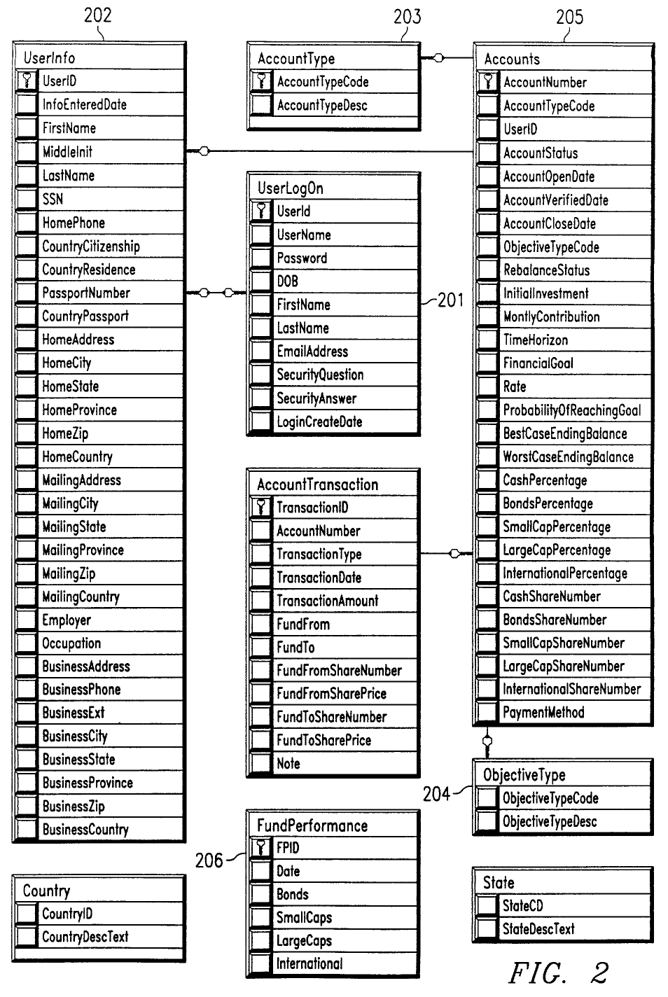

At Step 101, the user or potential user accesses system 100 home page (Index.htm) via a global computer network, such as the Internet or the World Wide Web, a software browser, and terminal hardware, such as a personal computer. A potential new client is prompted to register at Step 102. In response to the prompt, the potential client enters such information as a user name, user Email address and a user selected password (collectively the “user identification”). This information is then stored in the system database. A preferred data structure or Account Profile 200 is shown in FIG. 2, which includes a block 201 populated with the user identification information and additional access security data. The access security information, which either is requested from the user or generated by system 100, may include for example an assigned user ID, user date of birth, and security questions and answers. Once registration is complete, the newly registered user is returned to the home page (Block 101).

Registered users login from the home page by entering their user identification and answering any security questions which are presented. The entered information is then checked at Step 103 against the information in the database. If a match is not found at Step 103, the user has at least three choices at Step 104. First, a new attempt to login can be made, in case an error was made during the initial attempt to login. Second, the user may return to Step 102 and register, if the user has not already done so. And third, if the user has forgotten his or her password, then at Step 105, the expected login information, such as the user name and email address, for that user is retrieved from the database and compared with that information actually input by the user at Step 106. If no match occurs, the system administrator must be contacted at Step 107, otherwise, an Email is sent to the user with the correct password at Step 108. The user is returned to the home page at Step 109.

Next, consider the case where the login is successful at Step 103. At Step 110, a check is made to determine if the user has an established account with respects to the given user information. For discussion purposes, assume first that an account has not been established. The user is then given the choice (Step 111) of either changing the registration information by returning to Step 102 or opening an account.

The user can either directly open an account or view a demo of the features of an account. (Step 112) For purposes of discussion, it will be assumed that an actual or “live” account is being opened. The demonstration will then be similar, with the exception that simulated data and simulated processing steps will be used.

At Step 113 the user is prompted to input information such home and business addresses, social security number, home and business telephone numbers and similar relevant information, shown for example in block 202 of the Account Profile of FIG. 2. The Account Profile is preferably pre-populated with the data already available from the registration steps. The information entry is checked for completion at Step 114 and the database appropriately updated.

An account type is selected from a set of available account types set up in the system database at Step 115. The account type is preferably recorded by an Account Type Code and Account Type description in the database, for example in block 203 of data structure 200.

Similarly, at Step 116 the user selects an investment objective in response to an online objective questionnaire. For example, the user may enter such information as a desired initial investment, desired monthly contribution and time horizon over which the expected return is to be measured. Additionally, the user preferable enters either a desired rate of return or a financial goal, in terms of accumulated value at the time horizon. If only one rate of return or financial goal factors is entered, the other can be derived from the system. An corresponding Objective Code and Objective Description are stored in block 202 of data structure 200.

For the objective of wealth accumulation, the user is presented with a risk questionnaire. The risk questionnaire is aimed at determining both the ability to take risk and the willingness of the user to take risk. For example, the ability to take risk may take into account such factors as current wealth, liabilities and commitments, length of investment horizon and financial need. Generally, the greater the wealth, the greater the ability to accept loss while the more liabilities and commitments, the lower the degree of tolerance to loss. A more distant time horizon generally means more risk can be taken since a longer recovery period is available. Greater financial needs may dictate that additional risk be taken to meet those needs.

The willingness to accept risk is generally a function of the personality of the inventor. For example, some investors are historically more conservative than others. Som personalities generally favor more risky advocations than others. A typical questionnaire designed to evaluate ability and willingness to take risks will include questions directed at such factors as income, expected income growth, attitudes towards investment value and types of investment products, attitude toward potential risk versus potential reward, percentage of savings available to invest, any required income from an investment, amount of liquid assets required and approach to everyday affairs.

At Step 118, the data from the Risk Questionnaire and/or the Objective Questionnaire is used by the Planner tool, at Step 118 and the Selector tool at Step 119. The Planner tool is preferably a Java-based tool which allows investors to see graphically and dynamically how changes in key input variables (e.g. initial investment amount, investment horizon, financial goal etc.) affect the desired rate of return and level of risk. In the preferred embodiment, a graphical slide bar is provided which can be moved up and down to change the input variable. This allows the investor to answer investment questions such as:

1. How much return is required from the investment in order to reach the investment goal of sending a child to college or purchasing a house?

2. How much risk is required to achieve that return?

3. How much would the return and risk change if the initial investment amount, the monthly contributions, the financial goal, and/or the horizon date change.

The Selector tool allows the investor to select between 5 different portfolio mixes, each having a probability of %50 percent or greater of achieving the investment goal. For each of the optimal portfolios, key statistics are made available to the investor including indicators of the Best, Most Likely, and Worst-case scenarios, the probability of achieving the desired goal and the probability of a loss. In the preferred embodiment, this tool provides a graphics presentation to the investor which sets out the risk associated with a given portfolio mix in terms of real dollars. From the best and worst case scenarios, the investor can then implicitly decide his or her tolerance to risk.

At Step 120 the account information is verified and any desired adjustments made by the user, for example by changing entries of Objective and Risk Questionnaires. The Planner and Selector tools can the be re-run for the new data. Once the account information is confirmed, the user is prompted to select a payment option at Step 121. Payment can be made by any of the traditional vehicles including credit cards, debit cards, checks, a prepaid account, etc. Once payment has been secured, the database is updated at Step 122 and the account activated.

Returning to Step 110, the case where the logged-in user already has an active account can now be considered. At Step 123, the account holder has several different options including, in the preferred embodiment, the capability of obtaining an account summary, to withdraw completely, to change the portfolio asset mix, change the contribution levels, change user information, or open another account.

One of the primary advantages of the inventive concepts comes from the fact that the account holder can at all times access detailed information concerning account status and account performance. In FIG. 1, this feature is represented by Step 124. At Step 125, account data including relevant dates, account status, asset mix as percentage of product, current probability of reaching the state goal, among other things, is accessible to the user from the database. A preferred Account Profile data structure is shown as block 205 in FIG. 2. At Step 126, account performance data are accessed. A preferred account performance database structure is shown in FIG. 2, block 206. In this case, the total fund performance, as well as the performance of each investment product, are tracked by date.

System 100 can also provide the user (client or account holder) with a rebalancing recommendation at Step 127. The user can accept or decline (cancel) rebalancing of the portfolio, with any acceptance confirmed at Step 128 and the database correspondingly updated at Step 129. At anytime, the account holder can withdraw from a fund, buy assets or sell assets (Steps 130-131). Moreover, the asset mix can be changed (Step 132) or the contribution amount changed (Step 133).

To open a second account, the same procedure described above is performed, starting at Step 112. Similarly, to update or change the user account information, the system returns to Step 113 and proceeds accordingly. In each case, the account is activated after any required payments are made.

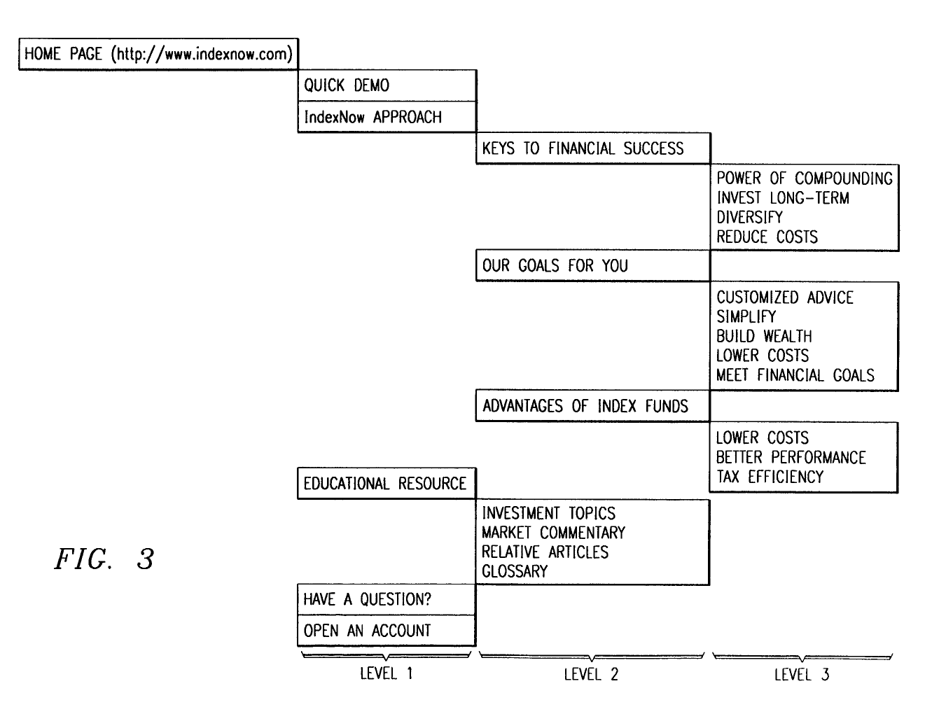

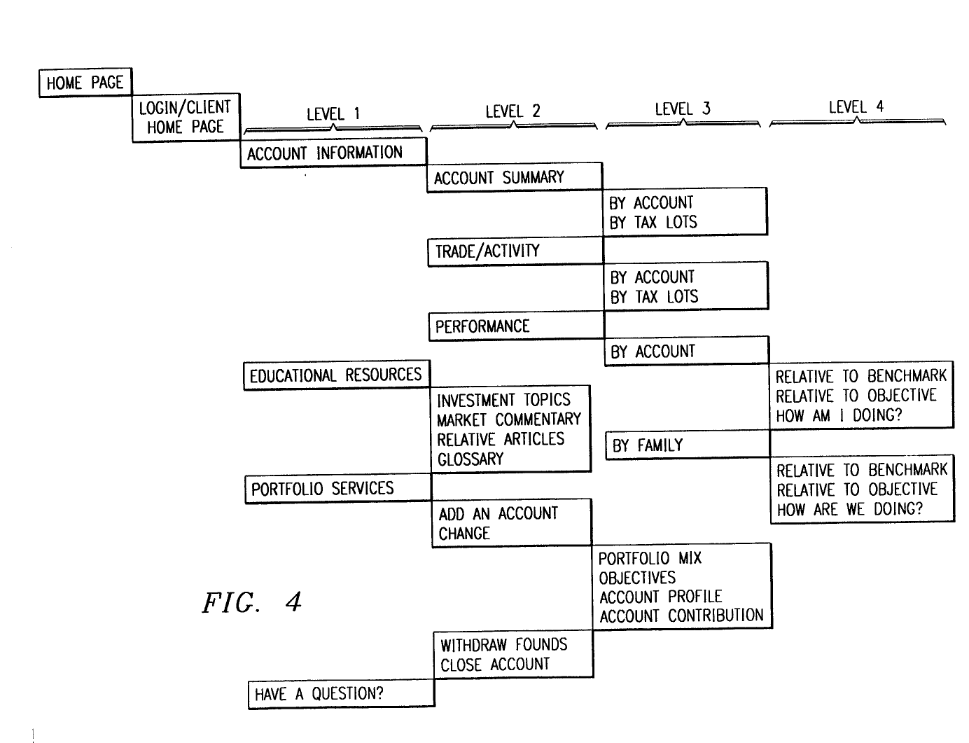

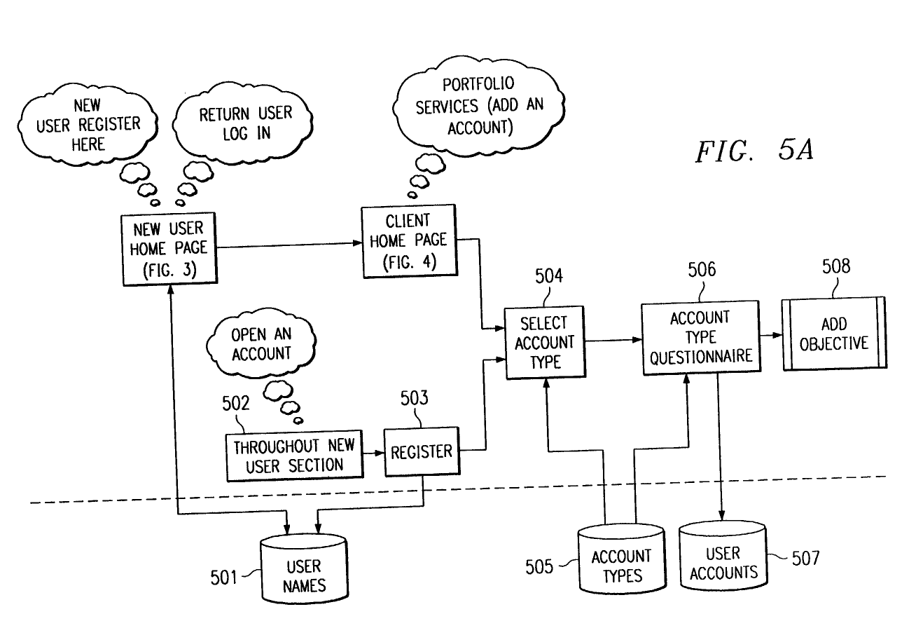

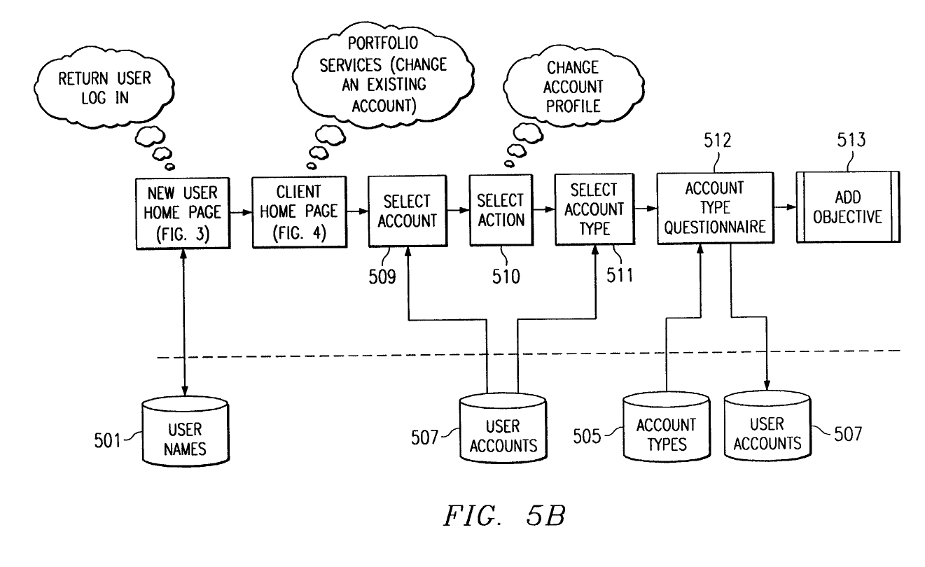

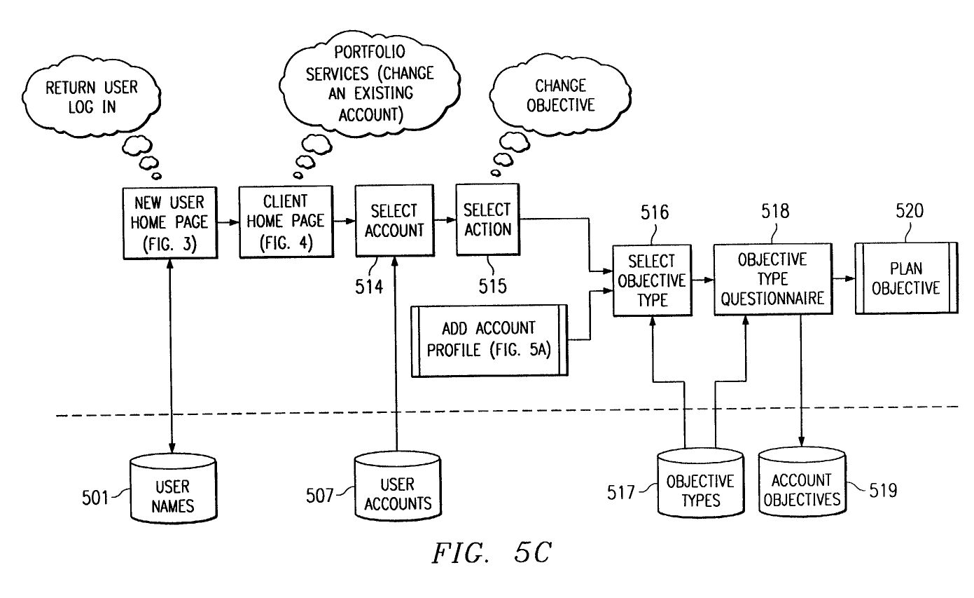

FIG. 3 is a diagram showing the menus available on the preferred New User Home page. At the highest level (Level 1) a new user can select from the Quick Demo, IndexNow Approach, Educational Resources, Have a Question?, and Open An Account options. In turn, the Level 2 and 3 selections allow access to more specific information concerning investing in general,

Indexed products and the capabilities of system 100 in helping manage such products. It should be noted that the depicted menu structure is only one of the possible menu structures that can be used to implement the present inventive concepts.

By clicking on the Quick Demo option, a presentation is run demonstrating the primary features of system 100 described above in conjunction with the flow chart of FIG. 1. Any detailed questions the user might have can be addressed through the system administrator and Email by clicking on the Have a Question? menu entry. The user is also provided with general investment information, including access to published articles and papers, market commentaries, a glossary, through the Educational Resource menu and its submenu.

The IndexNow Approach option provides the user with more specific information concerning the capabilities of system 100. In the illustrated embodiment, the Keys to Financial Success Level 2 option pulls-down Level 3 selections describing, in theory, the Power of Compounding, Investing Long Term, Portfolio Diversity and Reducing Costs. The option entitled Our Goals For You pulls-down selections providing explanations of the services and advantages available using system 100, including on-line Customized Advice, Simplified portfolio management, Building Wealth, Lowered Costs, and a method of achieving the user's Financial Goals. The Advantages of Index Funds menu particularly describes the performance and advantages of index funds, including their Lower Costs, improved Performance and Tax Efficiency.

A similar diagram is provided as FIG. 4 describing the preferred menus and options available for the registered user (client). Again, many different webpage designs can be used to practice the present inventive principles. The Level 1 menu selections direct the user to Account Information, Portfolio Services, Educational Resources and obtaining assistance in answering questions. The Educational Resources and Have a Question? options are the same as described above with respects to the New User HomePage.

By pointing to the Account Information selection, the user can obtain current information with regards to one or more portfolios held by that user. Access can be a function of Account Number, Tax Lot, or other identifier. An Account Summary selection allows information from the Account block 205 from the corresponding Account Profile 200 (FIG. 2) to be retrieved and displayed. Similarly, the stored Account Profile can be accessed to track trades and other portfolio activity, as well as to determine portfolio performance. Portfolio performance can be measured, for example, against a selected benchmark or account objective.

The Portfolio Services menu allows the user to make changes to the account, including changing the Portfolio Mix, the Objectives, Account Profile and/or Account Contribution. The options of Withdrawing Funds and Closing Account can also be exercised.

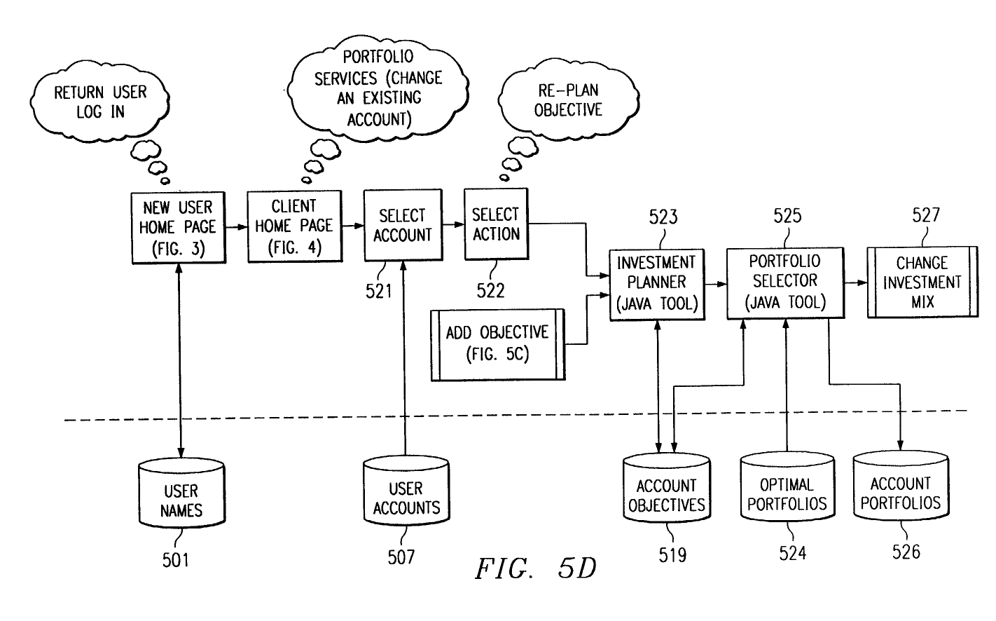

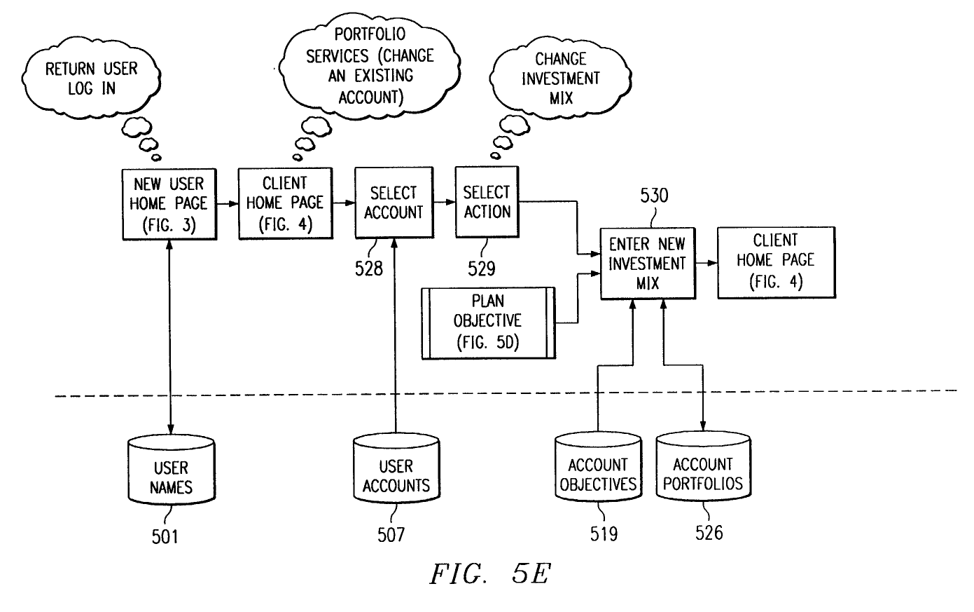

FIG. 5A is a diagram illustrating in further detail a preferred procedure for adding an Account Profile to the database. An Account profile can be added from either the New User Home Page (FIG. 3) or the Client Home Page (FIG. 4).

From the New User Home Page, the new user name, password, and Email address (user identification) are added to the User Names database 501. Once the required information for a new user is entered into the database, that user can then Register at any point (Blocks 502 and 503) with respects to FIG. 1 using the Open Account Option on the webpage. Once registered, the new user (client) is authorized to execute the Add Account procedure. Previously registered clients can add a new account profile by immediately selecting the Add Account Option from the Portfolio Services menu of the Client Home Page. The first step (Block 504) in the Add Account procedure is selecting from the available account types in the Account Type database 505. Once the account type is selected, the user fills out a corresponding electronic Account Type Questionnaire (Block 506). The information obtained through the Account Type Questionnaire is stored in the User Accounts Database 507. After the Account Profile, the preferred structure of which is shown in FIG. 2, is added to the database, the user can the proceed to the procedure for setting up the account objective (Block 508).

The preferred procedure for changing an existing account is illustrated in FIG. 5B. Again, new users enter by registering from the New User Home Page (FIG. 3) and existing clients enter directly from the Client Home Page (FIG. 4). In this case, the account to be modified is called up from the User Accounts database 507(Block 509). Then, the user selects the Change Account Profile option from the Client Home Page (Block 510). A new account type can be selected from those available in the Account Types database (Block 511). A new Account Type Questionnaire is subsequently filled out (Block 512) and stored in the User Accounts database 507. The user goes on to add objective information with respects to the updated Account Profile (Block 513).

A preferred procedure for changing the Account Objective is illustrated in FIG. 5C. Similar to the procedures shown in FIGS. 5A and 5B, new users and existing clients enter through their respective Home Pages (FIGS. 3 and 4). The corresponding Account information is retrieved from the User Accounts database (Block 514) and the user selects the Change Objective option from the webpage (Block 515). At this point, the user can select (Block 516) from the available objectives in the Objective Types database 517. Additionally, this step can also be reached through the Add Account Profile procedure of FIG. 5A. In any case, to change the objective, the user fills-outs a corresponding Objective Type Questionnaire (Block 518), which is duly stored in the Account Objectives database 517. The new objective criteria and/or the new account profile can then be used to generate a new plan for the client (Block 520).

The Planning (Replanning) procedure is shown in further detail in FIG. 5D. This option is available to registered users through the Change In Existing Account option in the Portfolio Services submenu. Also, as discussed immediately above, the planner feature can also be reached through the process of changing the Account Objective.

To replan, the Account Profile at issue is retrieved from the User Account database (Block 521) and the Re-plan Objective options is selected (Block 522). Using the account objective data from the Account Objectives database 519, the Investment Planner tool is run (Block 523), followed by application of the Portfolio Selector tool (Block 525). The Portfolio Selector tool selects the optimal portfolio that best matches the user's account type and objectives using the data from the Optimal Portfolios database 524. The selected portfolio is stored in the Account Portfolio database 526 referenced to the account selected by the user. The investment mix can then be changed (Block 527) as the user desires.

The preferred process for changing the investment mix is shown in FIG. 5E. It can be entered by registered users (clients) through the home pages (i.e. the Change an Existing Account option) or from the Objective Planning procedure of FIG. 5D. The account to be changed is retrieved from the User Accounts database 507 (Block 528) and the Change Investment Mix option selected from the corresponding menu entry (Block 529). Using information from the Account Objectives database 519, the user makes the desired changes to the account investment mix (Block 530) and the Account Portfolios database 526 is appropriately updated. On completion of all the required account activity, the user is returned to the Client Home Page.

Although the invention has been described with reference to a specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims will cover any such modifications or embodiments that fall within the true scope of the invention.

What is claimed:

1. A method of managing indexed investment products via a computer network comprising the steps of:
generating a set of portfolios, each portfolio composed of weighted classes of assets and associated with a degree of loss aversion;
storing the set of portfolios in a database;
generating a set of return distributions for each portfolio for selected investment options and horizon dates;
storing the set of return distributions in the database;
matching a selected portfolio with an online investor in response to degree of loss aversion information input from the online investor; and
providing to the online investor a return distribution associated with the selected portfolio in response to investment option and horizon date information input from the online investor.

2. The method of claim 1 and further comprising the step of determining the investor degree of loss aversion from information input by the investor through an online risk questionnaire.

3. The method of claim 1 wherein said step of generating a set of portfolios comprises the step of selecting an asset class mix for each portfolio as a function of the moments of mean, standard deviation and kurtosis.

4. The method of claim 3 wherein said step of generating a set of portfolios comprises the substep of maximizing a utility function.

5. The method of claim 4 wherein said substep of maximizing a utility function comprises the substep of maximizing a log utility function.

6. The method of claim 1 wherein said step of generating a set of return distributions comprises the substeps of:
estimating a return distribution for a first time period from a joint return distribution of the asset classes of a selected portfolio;
performing a Monte Carlo simulation from the return distribution for the first time period to generate a random path of return samples through subsequent time periods up to the horizon date; and
calculating a compounded average rate of return for the return samples taken from the random path.

7. The method of claim 1 wherein the computer network comprises a global computer network selected from the group comprising the Internet and the World Wide Web.

8. The method of claim 1 wherein the asset classes are selected from the group comprising fixed income, United States stocks, and International stocks.

9. The method of claim 1 wherein said step of generating a set of portfolios of weighted classes of assets and associated with a degree of loss aversion, comprises the step of generating a set of portfolios factoring in the degree of loss aversion as a secondary effect.

10. An networked system for investing in indexed products online operable to:
select an account type from account type information input by an online user of the networked system;
select an account objective type from account objective type information input by the online user of the networked system; and
select an account portfolio for the on-line user as a function of the selected account and account objective types.

11. The networked system of claim 10 further operable to:
present an online account type questionnaire to the online user; and
receive the account type information from the online user in response to the account type questionnaire.

12. The networked system of claim 10 further operable to:
present an online account objective type questionnaire to the online user; and
receive the account objective type information from the online user in response to the account objective type questionnaire.

13. The networked system of claim 10 further comprising a database storing at set of optimal portfolios and operable to select the account portfolio from the set of optimal portfolios.

14. The networked system of claim 13 wherein each of the set of optimal portfolios is generated using the moment kurtocity.

15. The networked system of claim 13 wherein each of the set of optimal portfolios is generated using the moments of mean, standard deviation and kurtocity.

16. The networked system of claim 13 wherein each of the set of optimal portfolios is associated with a degree of loss aversion factor and the system is further operable to select the account portfolio as a function of the degree of loss aversion factor associated with a corresponding one of the optimal portfolios and a degree of loss aversion factor derived from the account objective questionnaire.

17. The networked system of claim 10 based at least in part on a global computer network selected from the group comprising the Internet and World Wide Web.

18. Software for effectuating online investments comprising:
an account type selection procedure for:
displaying an account type questionnaire on an end user terminal;
receiving account type selection information input through the end user terminal in response to the account type questionnaire; and
selecting an account type from a set of available account types in response to the received account type information;
an objective type selection procedure for:
displaying an objective type questionnaire on the end user terminal;
receiving objective type selection information input through the end user terminal in response to the objective type questionnaire; and
selecting an account objective type from a set of available account objective types in response to the received objective type selection information; and
an account portfolio selection procedure for selecting a portfolio from a plurality of available portfolios as a function of the selected account type and the selected objective type.
